(19) United States
(12) Patent Application Publication
(10) Pub. No.: US 2003/0144010 A1
(43) Pub. Date: Jul. 31, 2003

(54) Method and apparatus for determining wirelessly the position and/or orientation of an object

(75) Inventor: Franz Dollinger, Unterhaching (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/294,797

(22) Filed: Nov. 15, 2002

Related U.S. Application Data
(63) Continuation of application No. PCT/DE01/01632, filed on Apr. 30, 2001.

(30) Foreign Application Priority Data
May 18, 2000 (DE) 10024474.2

(51) Int. Cl. H04Q 7/20

(52) U.S. Cl. 455/456; 455/23

(57) ABSTRACT

A method and device for determining wirelessly at least one object (7) position and/or orientation. An electromagnetic interrogation signal is transmitted via radio signal from an interrogating station (14). Detecting elements (1-3), located on the object (7) and storing power, individually modulate the recorded interrogation signal and forward it, as coded response signals, to the interrogating station (14). There, the position and/or orientation of the object (7) is/are determined from time interval values and/or phase values of each response signal.

This is a Continuation of International Application PCT/DE01/01632, with an international filing date of Apr. 30, 2001, which was published under PCT Article 21(2) in German, and the disclosure of which is incorporated into this application by reference.

### FIELD OF AND BACKGROUND OF THE INVENTION

The invention relates to a method for wireless determination of at least one of position and orientation of at least one object. The invention further relates to an apparatus for wirelessly determining at least one of position and orientation of at least one object.

It is known for the position(s) of an object or for a number of objects to be determined with the assistance of reflection of electromagnetic radiation, for example by image recognition, radar and the like. It is also known for orientation identification to be carried out with the aid of inclination sensors. However, in order to accomplish this, a direct visual link is normally required for radar or image identification, and wiring to the object is generally required for inclination sensors.

Furthermore, sensor elements in the form of surface acoustic wave (SAW) components are known, for example, from EP 0 619 906 B1, which can temporarily store a checking signal. The electromagnetic checking signal is converted to an acoustic signal, and is modified with a predetermined basic delay and/or frequency, during the temporary storage. The modified acoustic signal is converted to a coded electromagnetic response signal and is sent back to a checking station, which has transmitted the checking signal, in order to obtain specific dimension data. The SAW component operates passively, i.e., it does not require its own energy source or power supply. The power requirement is provided by the electromagnetic checking signal, which is stored upon reception. Such SAW components, which operate as passive transponders, may be used for various measurement purposes for temperature, pressure or acceleration measurement. Furthermore, they may be used in identification systems, with different reflector structures being used on the piezoelectric substrate of the SAW component for modulation of the acoustic SAW signal. By way of example, EP 0 651 344 discloses the provision of a spread spectrum reflector on the substrate of the SAW component. The SAW component then represents a so-called ID tag, which is used as an identification mark.

A method and an apparatus for wirelessly determining the position and/or orientation of an object are known, e.g., from EP 0 618 460 A2. Here, position determination is carried out by calculating the delay times and, at very short ranges, the phase changes with respect to a reference phase.

### OBJECTS OF THE INVENTION

One object of the present invention is to provide a method and an apparatus for determining the position and/or orientation of one or more objects of the type described above, without the use of wires. It is a further object of the invention to provide such a method and apparatus with which one can determine as precisely as possible the position and/or the orientation of objects that are difficult to observe or supervise or that are subject to other monitoring hindrances.

### SUMMARY OF THE INVENTION

These and other objects are achieved, according to one formulation of the invention, by a method for wireless determination of position and/or orientation of at least one object, including: (a) transmitting an electromagnetic checking signal from a specific transmission location to the object; (b) modulating the checking signal with passive sensor elements respectively differently at a number of different points of the object; (c) sending back the modulated checking signal from the sensor elements as respective differently coded response signals; and (d) determining the position and/or the orientation of the object, taking into account at least one of delay times and phase differences between the response signals from the sensor elements. According to another formulation, the objects are achieved by an apparatus for wirelessly determining the position and/or orientation of at least one object, the apparatus including: (a) a checking device that transmits checking signals; (b) an evaluation device that evaluates response signals in order to determine the position and/or the orientation; and (c) a sensor device provided on the object and having a plurality of passive sensor elements, which are coupled to antennas that are arranged at mutually different locations on the object, and which send response signals in accordance with the checking signals. The sensor elements include individual modulation devices that produce respective coded response signals in response to the checking signals, and the evaluation device evaluates at least one of delay times and phase differences between the response signals from the sensor elements in order to determine the position and/or the orientation.

According to the invention, the checking signal, which is transmitted by radio wave and stored, is individually modulated with the aid of a number of energy-storing sensor elements. These elements are provided on the object and operate passively without their own power supply, and send back the signal to the transmission location of the checking signal as a coded response signal, whose timing and/or phase angle are respectively evaluated when determining the position and/or orientation of the object. As a result of their different positioning on the object, the sensor elements are at different distances from the checking station. This results in time and/or phase differences between the coded response signals, and in different delay times between the checking station and the respective sensor elements.

The modulation in the respective sensor element may be based on a different delay and/or frequency influence. The sensor elements are preferably in the form of SAW components with an ID tag function. An evaluation device, which is provided in the checking station, uses the mutually different modulation or coding of the received response signals to identify the respective sensor from which the response signal has come. This allows the respectively measured value for the delay time or phase angle to be associated with the appropriate sensor element.

Further exemplary embodiments for the respective sensor element are SAW resonators, electrical and mechanical resonant circuits, such as crystal volume oscillators and LC resonant circuits.

One advantageous feature of the described energy-storing sensor elements is that the energy is stored in the element sufficiently long that environmental echoes of the checking signal (checking pulse) have decayed to the point that the response signals emitted from the sensor element, although relatively weak, are nevertheless detected.

Using the delay time differences between the response signals coming from the sensor elements positioned at different locations on the object it is possible to determine the position and/or orientation of the object in space with respect to a reference location, in particular with respect to the checking station. The sensor elements have a fixed spatial relationship with the object, and this is stored in the evaluation device. The number of sensor elements used govern the degrees of freedom in which the measurement can be carried out, as well as the measurement accuracy. If three sensor elements are arranged at different locations on the object, it is possible to determine both the distance of the object from the checking station or from the reference location and the orientation of the object relative to it.

The invention allows the position and/or orientation of one or more objects to be determined, without making any contact with it, using a passive sensor device. The measurement arrangement is of simple design, with no direct visual link being required between the checking station and the object. The invention can preferably be used for driverless transport systems, for automatic positioning of objects, for the positioning of objects which are difficult to observe, supervise or monitor, and for monitoring systems and system parts. The invention is also suitable for use in alarm systems, in systems for assisting the disabled, and for personnel safety, security and convenience systems.

### BRIEF DESCRIPTION OF THE DRAWINGS

The invention will be explained in more detail using an exemplary embodiment and with reference to the figures, in which:

FIG. 1 shows, schematically, the basic design of an exemplary embodiment of the invention;

FIG. 2 provides an explanation of the evaluation of the electromagnetic response signals emitted from the sensor elements, and

FIG. 3 shows one embodiment of a sensor element and of a checking station which can be used for the invention.

### DETAILED DESCRIPTION OF THE PREFERRED EMBODIMENTS

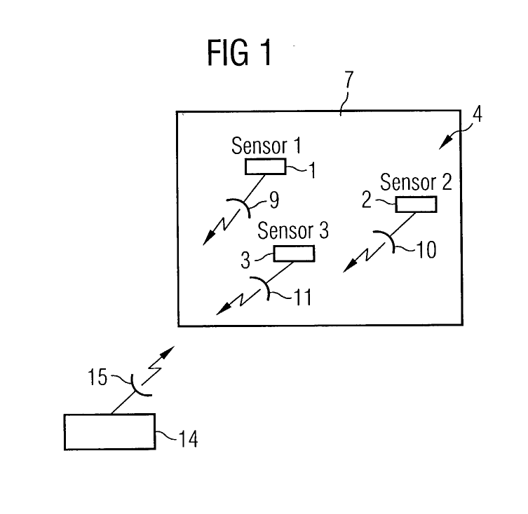

In FIG. 1, three sensor elements 1, 2 and 3 are arranged at different locations on an object 7. The illustrated position and orientation determination system also includes a checking station 14 with a transmitting/receiving antenna 15. The checking station 14 also has a transmitter 12 and a receiver 13, which are or can be connected to the transmitting/receiving antenna 15 (FIG. 3). Furthermore, the checking station 14 has an evaluation device 5, in which the transmitted and received signals are evaluated. The manner of configuring a checking station such as this is known in the art and need not be described in further detail here.

The respective sensor elements 1 to 3 each comprise SAW components, e.g., of a known embodiment. Each sensor element essentially has one associated receiving/transmitting antenna. As can be seen from FIG. 1, the sensor element 1 is associated with the antenna 9, the sensor element 2 is associated with the antenna 10, and the sensor element 3 is associated with the antenna 11. Each of these receiving/transmitting antennas is connected to an interdigital transducer 8 at the respective sensor element (FIG. 3). The interdigital transducer 8 is used to produce a surface acoustic wave (SAW) in a piezoelectric substrate 16 of the SAW component, and this surface acoustic wave is modulated in a modulation device 6. The modulation device 6 may comprise different reflector structures or resonator structures formed by convolution. This results in modulation with regard to the delay and/or frequency of the surface acoustic wave signal. This modulated signal is converted back by the transducer 8 to an electromagnetic RF response signal, which is sent back via the receiving/transmitting antenna of the respective sensor element to the checking station 14.

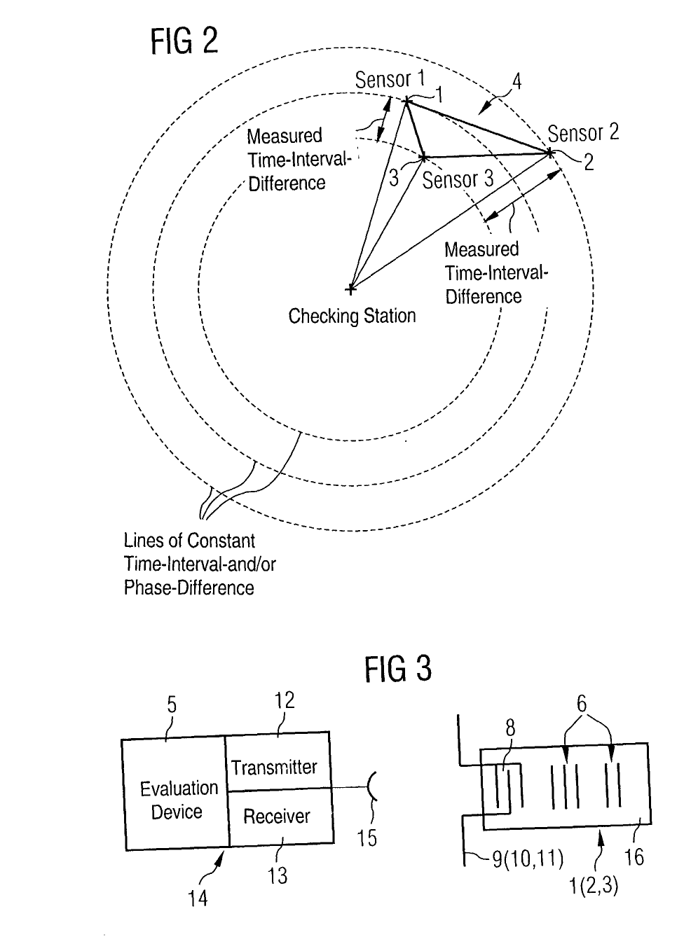

In the illustrated exemplary embodiment, the respective sensor elements 1 to 3 are thus stimulated by the checking station 14 with a checking signal, in particular with a pulsed RF checking signal, for example at 2.45 GHz. The response signal coded by the modulation is transmitted with the respective time delay produced by the sensor element from the respective associated receiving/transmitting antennas 9, 10, 11 of the sensor elements, and is received via the receiving section 13 of the checking station 14. In particular, the spatial arrangement of the receiving/transmitting antennas 9 to 11 which are associated with the respective sensor elements 1 to 3 is provided in a fixed manner on the object 7, and is stored in the evaluation device 5. For example, it is possible to accommodate the sensor elements 1 to 3 in a common unit or in a common module, and to connect them to the respectively associated antennas 9 to 11. The different distances at which these antennas 9 to 11 are located from the transmitting/receiving antenna 15 of the checking station 14 depending on the position and orientation of the object can be determined from the respective delay times and/or phase angles of the response signals. The path-length differences between the individual antennas 9 to 11 and the antenna 15 of the checking station 14 can be determined from the different delay times and phase angles as well as the delay time differences between the individual response signals, via the speed of light. Thus, the distance and/or orientation of the object 7 with respect to the checking station or with respect to some other reference location can be determined from this using known trigonometric relationships. This is illustrated in FIG. 2.

Since the system is invariant with respect to rotation about the checking station, if desired, an additional direction-finding device or an additional antenna can be provided on the checking station 14, so that it is also possible to determine the direction in which the object 7 is located.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for wireless determination of at least one of position and orientation of at least one object, comprising:
transmitting an electromagnetic checking signal from a specific transmission location to the object;
modulating the checking signal with passive sensor elements respectively differently at a number of different points of the object;
sending back the modulated checking signal from the sensor elements as respective differently coded response signals; and
determining the at least one of the position and the orientation of the object taking into account at least one of delay times and phase differences between the response signals from the sensor elements.

2. The method as claimed in claim 1, wherein said modulating includes a fixed predetermined delay.

3. The method as claimed in claim 1, wherein said modulating is carried out with a fixed predetermined frequency.

4. The method as claimed in claim 1, wherein the checking signal is modulated respectively differently by the sensor elements at three different locations on the object.

5. The method as claimed in claim 1, wherein:
said transmitting comprises storing the electromagnetic signal via radio in the respective sensor elements;
said modulating comprises converting the stored signals to respective modulated acoustic signals, converting the modulated acoustic signal to the respectively differently coded response signals, and sending the response signals back to the transmission location; and
said determining comprises evaluating the at least one of the delay times and the phase differences in order to determine the at least one of the position and the orientation.

6. An apparatus for wirelessly determining at least one of position and orientation of at least one object, comprising:
a checking device that transmits checking signals;
an evaluation device that evaluates response signals in order to determine the at least one of the position and the orientation; and
a sensor device provided on the object and having a plurality of passive sensor elements, which are coupled to antennas that are arranged at mutually different locations on the object, and which send response signals in accordance with the checking signals;
wherein the sensor elements comprise individual modulation devices that produce the respective coded response signals in response to the checking signals; and
wherein said evaluation device evaluates at least one of delay times and phase differences between the response signals from the sensor elements in order to determine the at least one of the position and the orientation.

7. The apparatus as claimed in claim 6, wherein said antennas are receiving and transmitting antennas.

8. The apparatus as claimed in claim 6, wherein said sensor device has three sensor elements whose antennas are arranged at mutually different locations on the object.

9. The apparatus as claimed in claim 6, wherein each of the modulation devices modulates with regard to at least one of delay and frequency.

10. The apparatus as claimed in claim 6, wherein the modulation devices utilize acoustic signals.

11. The apparatus as claimed in claim 6, wherein said evaluation device stores the locations at which the antennas associated with the sensor elements are mounted on the object.

12. The apparatus as claimed in claim 6, wherein said sensor elements comprise ID tags.

13. Apparatus comprising:
means for transmitting an electromagnetic signal from a transmission location to an object;
means for modulating the signal at a plurality of locations on the object to produce a plurality of respective modulated signals;
means for transmitting the respective modulated signals; and
an evaluation device configured to calculate positioning of the object from differences between the respective modulated signals.

14. The apparatus according to claim 13, wherein said means for modulating comprise passive sensor elements.

15. The apparatus according to claim 14, wherein said passive sensor elements each comprise a transducer configured to convert the electromagnetic signal into a non-electromagnetic wave and a modulator configured to modulate the non-electromagnetic wave.

16. The apparatus according to claim 13, wherein the positioning includes at least one of distance, relative position and orientation.

17. Apparatus comprising:
a transmitter of an electromagnetic signal from a transmission location to an object;
a plurality of passive sensor elements provided at predetermined locations of the object and converting the electromagnetic signal into a plurality of respective, mutually distinct response signals; and
an evaluation device configured to calculate positioning of the passive sensor elements from the respective, mutually distinct response signals.
